(19) United States
(12) Patent Application Publication
(10) Pub. No.: US 2011/0027062 A1
(43) Pub. Date: Feb. 3, 2011

(54) SYSTEM AND METHOD FOR IMPROVED WIND CAPTURE

(75) Inventors: Doug Moore, Riesel, TX (US); Kurt Knapton, Arlington, TX (US); Allen James Williston, Foristell, MO (US)

Correspondence Address: The Caldwell Firm, LLC, P.O. Box 59655, Dallas, TX, 75229, US

(73) Assignee: Abundant Energy, LLC, Plano, TX (US)

(21) Appl. No.: 12/510,260

(22) Filed: Jul. 28, 2009

(51) Int. Cl. F03D 3/04

(52) U.S. Cl. 415/1; 415/151

(57) ABSTRACT

A system for improved fluid capture comprises a first vertical turbine. A first radial vane support module comprises a first vertical pole and a second vertical pole and is disposed adjacent to the first vertical turbine. The first radial vane support module comprises a first radial vane storage module coupled to the first vertical support pole and the second vertical support pole and the first radial vane storage module comprises a first motor and a first radial vane. The first radial vane comprises a first retractable panel. The first motor couples to the first radial vane and is configured to extend and retract the first radial vane. A first radial vane control module couples to the first motor and is configured to control the operation of the first motor. In one embodiment, a saucer vane module couples to the first vertical turbine.

### TECHNICAL FIELD

The present invention relates generally to the field of electrical power generation using wind turbines and, more particularly, to a system and method for improved wind capture.

### BACKGROUND OF THE INVENTION

Electricity forms the backbone of modern society. Without electricity, much of the technology that brings order to the modern world would not function. As first-world nations continue to advance, and third-world nations industrialize and move into first-world status, the world faces increasing demands for electricity. Presently, commercial electrical generation primarily relies on electromagnetic induction, in which mechanical energy operates an electromagnetic induction generator to produce electricity. Generally, a power generation plant based on electromagnetic induction produces steam, and the steam causes a turbine to operate or spin. As the turbine spins, it produces power by operating an electromagnetic induction generator mechanically coupled to the turbine.

Production of steam requires a significant amount of energy. One method of steam production uses nuclear fission. In nuclear fission, a nuclear reaction occurs generating a large amount of heat. The nuclear power plant uses the heat generated by the nuclear reaction to boil water and produce steam. As described above, the nuclear power plant uses the produced steam to generate power. Unfortunately, nuclear power plants require significant capital to construct and operate. In many cases, the capital requirements limit use of nuclear power plants to those countries in which the government can subsidize the construction and operation of the plant, or to those countries where the individual consumer's wealth allows the consumer to afford an increased cost for the resultant electricity. In addition, the radiation produced by the nuclear reaction is extremely toxic, and the spent nuclear fuel remains radioactive for a significant period of time, which requires costly containment facilities for the spent fuel.

Another more common method of steam production for electrical power generation burns fossil fuels, such as coal, natural gas, and petroleum, to boil water and produce steam. This method of production avoids the risks of radioactive toxicity associated with nuclear power. Fossil fuels burn into a particulate matter that dissipates through the air, eliminating the need for expensive containment facilities associated with the radioactive fuel of nuclear reactors. Unfortunately, the particulate matter resulting from the combustion of fossil fuels contributes significantly to air pollution, which can cause problems of its own, including serious health problems for many individuals. When compared to nuclear power generation, startup costs to use fossil fuels to generate electricity are typically smaller. However, fossil fuels are a finite resource. As world demand for fossil fuels for electrical power generation and other uses increases, the world faces increased costs for fossil fuels, especially as fossil fuels begun to become scarce, potentially making fossil fuels cost prohibitive.

To combat problems with fossil fuels, some electrical power generation uses water and/or wind instead of steam to spin a turbine. Wind generation relies on naturally occurring wind or solar updraft towers that create wind artificially by using sunlight to heat air within a chimney. In both cases, power generation depends on the occurrence of a natural phenomenon. In the case of wind turbines, the turbine size necessary to generate appreciable electrical energy dictates fixation of the wind turbines to a specific location. Because the wind turbines are fixed, in the event that the wind ceases, the wind turbine ceases to generate electricity. Thus, wind turbines need an almost constant flow of wind; this limitation severely restricts suitable locations for wind turbine installation. In the case of a solar updraft tower, sunlight requirements limit installation to those areas that continually receive sunlight.

Moreover, traditional horizontal wind turbines common to most wind generation methods cannot operate in near ground turbulent wind conditions, and suffer structural fatigue due to downwind vortex shedding. These problems necessitate construction of very tall horizontal wind turbines that require large distances between each turbine. The increased size and necessary land mass increase capital costs.

Horizontal wind turbines also frequently require installation in a remote location due to size and height requirements, adding significant infrastructure costs to connect the horizontal wind turbine system to a main grid line. Furthermore, horizontal turbines often experience problems with maintenance at high elevations, such as, for example, bearing failure due to large thrust loads and high torque. In addition, horizontal wind turbines frequently need yaw control to position blades in line with a prevailing wind direction increasing the capital costs for horizontal wind turbines even further. Finally, horizontal wind turbines sometimes cause environmental concerns regarding rotating blades endangering bird populations.

Vertical wind turbines solve many of the above-described problems. Generally, vertical wind turbines operate in all manner of conditions, including near-ground turbulent wind conditions. In addition, vertical wind turbines do not suffer structural fatigue due to downwind vortex shedding as horizontal wind turbines do. The compact size of vertical wind turbines allow placement in smaller geographic locations and at lower heights easing maintenance and land acquisition costs. This also allows placement of vertical wind turbines near urban areas, thus facilitating connection to a main grid line. Because vertical wind turbines can capture wind from all directions, vertical wind turbines typically do not need yaw control. In addition, vertical wind turbine visibility is greater than that of horizontal wind turbines. The greater visibility eliminates many environmental concerns relating to bird endangerment. However, vertical wind turbines draw from a significantly smaller wind mass due to their smaller size, thus reducing the total power generation possible from each wind turbine.

One attempt to increase vertical turbine wind capture relies on fixed cloth panels configured in relation to the vertical turbine such that the panel funnels wind into the turbine from the side. While these fixed cloth panels assist in capturing wind, many problems still exist. For instance, common turbine installations occur in areas where the wind velocity can reach extremely high peak levels. In these installations, the wind often destroys the cloth material of the panel. The rigid nature of the panel installation compounds this problem. That is, in typical systems, the common cloth panels are usually permanently fixed at each installation. Because removal is not possible, the panels remain exposed to the wind even in high wind conditions that would otherwise shut down the vertical turbine. This increases the rate of wear and tear of common systems, and accelerates the eventual complete panel failure.

Therefore, there is a need for an improved wind capture method that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

A system for improved fluid capture comprises a first vertical turbine. A first radial vane support module comprises a first vertical pole and a second vertical pole and is disposed adjacent to the first vertical turbine. The first radial vane support module comprises a first radial vane storage module coupled to the first vertical support pole and the second vertical support pole and the first radial vane storage module comprises a first motor and a first radial vane. The first radial vane comprises a first retractable panel. The first motor couples to the first radial vane and is configured to extend and retract the first radial vane. In one embodiment, a first radial vane control module couples to the first motor and is configured to control the operation of the first motor. In one embodiment, a saucer vane module couples to the first vertical turbine.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 provides a perspective representation illustrating exemplary elements in accordance with one embodiment;

FIG. 2 provides a perspective representation illustrating exemplary elements in accordance with one embodiment;

FIG. 3 provides a schematic representation illustrating exemplary elements in accordance with one embodiment, deployed in an exemplary prevailing wind flow;

FIG. 4 provides a schematic representation illustrating exemplary elements in accordance with one embodiment, deployed in an exemplary prevailing wind flow;

FIG. 5 provides a perspective representation illustrating exemplary elements in accordance with one embodiment;

FIGS. 6-8 provide a schematic representation illustrating exemplary elements in accordance with one embodiment;

FIG. 9 provides a perspective representation illustrating exemplary elements in accordance with one embodiment; and

FIG. 10 provides a perspective representation illustrating exemplary elements in accordance with one embodiment.

### DETAILED DESCRIPTION

The particular values and configurations discussed in these non-limiting examples can be varied and are cited merely to illustrate at least one embodiment and are not intended to limit the scope of the invention. In the following discussion, numerous specific details are set forth to provide a thorough understanding of the disclosed embodiments. Those skilled in the art will appreciate that the disclosed embodiments may be practiced without such specific details. In other instances, well-known elements have been illustrated in schematic or block diagram form in order not to obscure the disclosed embodiments in unnecessary detail.

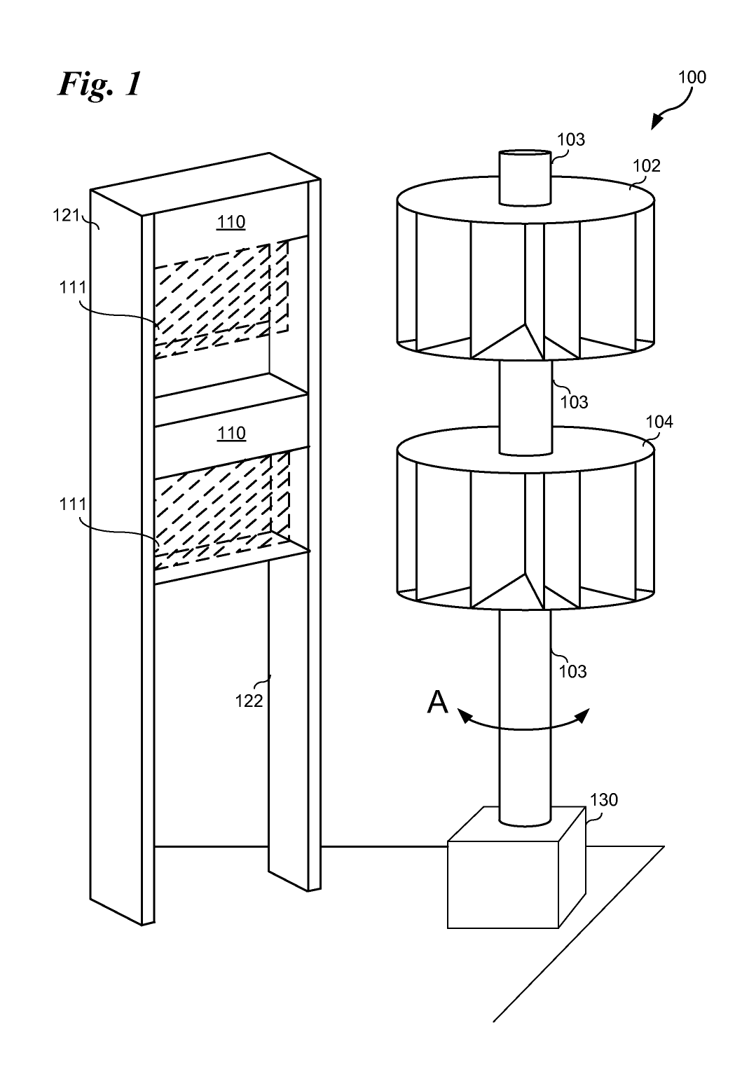

Referring now to the drawings, FIG. 1 illustrates an improved system 100 for wind capture. In the illustrated embodiment, system 100 includes a first turbine 102 and a second turbine 104 coupled to a turbine shaft 103. In the illustrated embodiment, turbine 102 and turbine 104 are vertical turbines configured to convert generally linear motion of a moving fluid, such as wind or water currents, into rotational energy conveyed to shaft 103, as indicated, for example, at arrow “A”. One skilled in the art will understand that the disclosed embodiments contemplate and include implementations with fewer turbines and more than two turbines. Additionally, one skilled in the art will understand that the rotational energy imparted to shaft 103 can be further transformed into electrical energy, such as by a generator, for example, housed in a control house such as control house 130, for example. Generally, such details have been omitted so as to improve discussion of the disclosed embodiments.

System 100 also includes a radial vane support module 120. Generally, in one embodiment, radial vane support module 120 provides a structural foundation and attachment point for a radial vane storage module 110. In the illustrated embodiment, radial vane support module 120 includes a first vertical pole 121 and a second vertical pole 122. In the illustrated embodiment, first vertical pole 121 and second vertical pole 122 are shown as upright plank-shaped support columns. One skilled in the art will understand that poles 121 and 122 can also be configured as poles, stanchions, posts, scaffolding, or other suitable vertical support member.

In the illustrated embodiment, radial vane storage module 110 couples to vertical pole 121 and vertical pole 122 such that poles 121 and 122 elevate and hold radial vane storage module 110 aloft and adjacent to turbine 102 and turbine 104. As used herein, a radial vane is “adjacent” to a turbine and/or turbine stack when it is sufficiently close in proximity such that, in operation, fluid that would otherwise pass by the turbine and/or turbine stack is instead directed toward the power side of the turbine or turbine stack, or directed away from the drag side of the turbine and/or turbine stack. Generally, as used herein, a radial vane is “in operation” when it is not fully retracted. As used herein, a “turbine stack” is a system of one or more vertical turbines coupled vertically to the same vertical turbine shaft, such as shaft 103, for example.

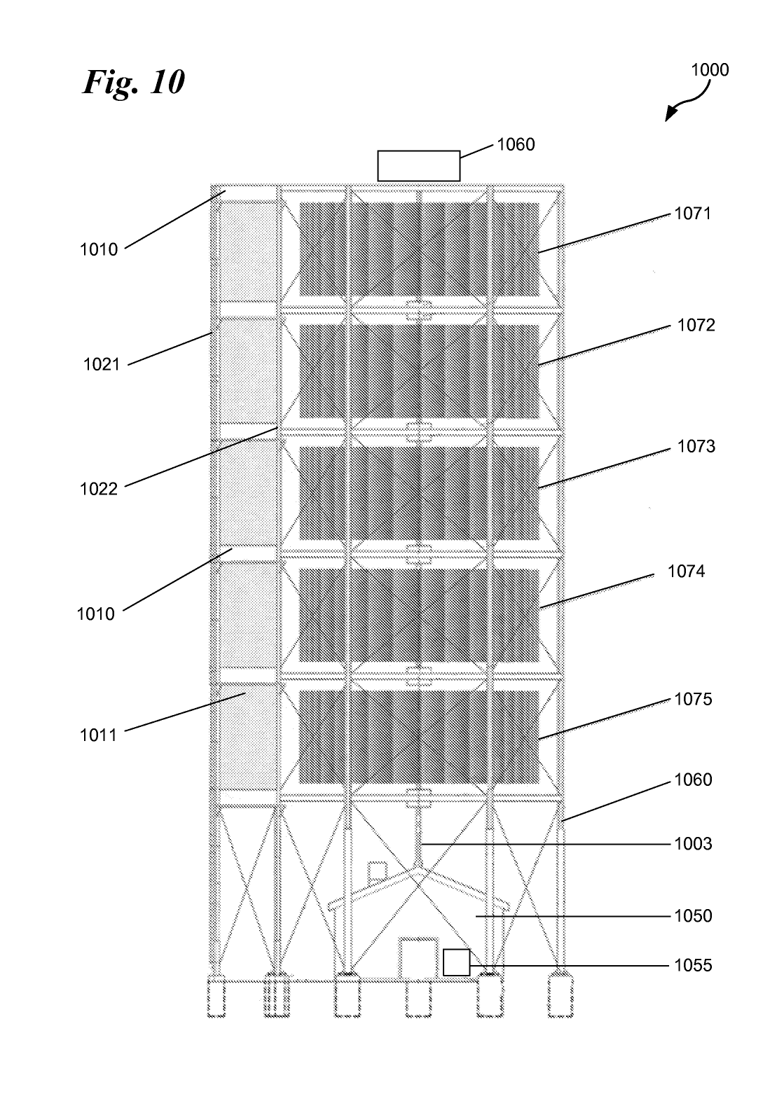

One skilled in the art will understand that vertical turbines are sometimes configured with a support framework that includes support members outside the rotational circumference of the turbine. As such, in one embodiment, vertical pole 121 or vertical pole 122 may comprise a portion of such support framework. FIG. 10, below, illustrates one such framework in an exemplary configuration. One skilled in the art will understand that the disclosed embodiments contemplate and include any suitable support structure for radial vane storage module 110.

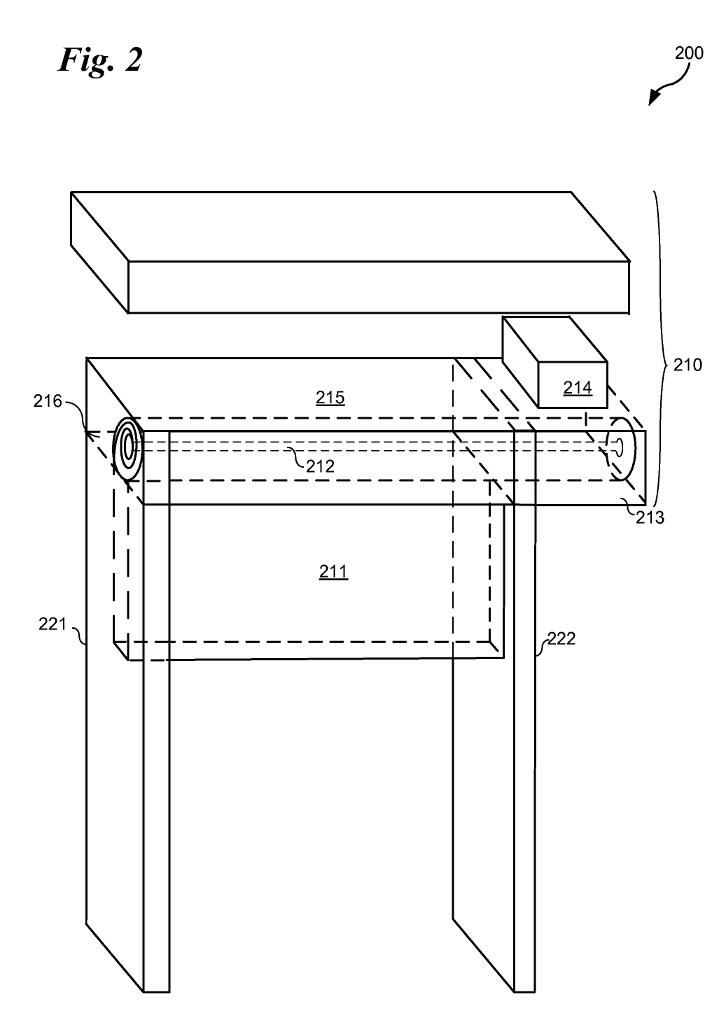

In the illustrated embodiment, radial vane storage module 110 includes an enclosure providing containment of radial vane 111 and, among other things, additional elements of the disclosed embodiments as illustrated in FIG. 2, below. In the illustrated embodiment, radial vane support module 120 includes two radial vane storage modules 110. One skilled in the art will understand that radial vane support module 120 can include a number of radial vane storage modules 110. In one embodiment, radial vane support module 120 includes one radial vane storage module 110 for each turbine coupled to turbine shaft 103.

FIG. 2 illustrates an exemplary radial vane system 200. In the illustrated embodiment, system 200 includes a radial vane storage module 210, shown in an expanded view. In the illustrated embodiment, radial vane storage module 210 includes a radial vane 211, a base member 216, an upper member 215, an axle 212, a motor 213, and a radial vane control module 214. In the illustrated embodiment, base member 216 comprises a lower portion of an enclosure to which other elements of radial vane storage module attach. Additionally, in the illustrated embodiment, base member 216 also defines an opening through which a radial vane 211.

In the illustrated embodiment, upper member 215 couples to base member 216 and is configured to form an enclosure enveloping other components of system 200, as described below. As such, in one embodiment, base member 216 and upper member 215 together shield the components enclosed therein from some of the corrosive effects of the local environment. Additionally, in one embodiment, base member 216 and upper member 215 together provide a framework by which radial vane storage module 210 couples to radial vane support module 220.

In the illustrated embodiment, radial vane 211 includes a retractable panel coupled to an axle 212. Generally, radial vane 211 can be configured in two primary configurations. In the first configuration, the “engaged” position, radial vane 211 is extended axially from axle 212. So configured, radial vane 211 redirects fluid according to the angle between vane 211 and the wind direction. In the second configuration, the “disengaged” position, radial vane 211 is retracted. In one embodiment radial vane 211 retracts such that vane 211 wraps around axle 212 and is disposed entirely within radial vane storage module 210. So configured, wind/fluid may pass between support poles 121 and 122, generally unencumbered by radial vane 211.

One skilled in the art will understand that radial vane 211 can also be deployed in configurations between fully extended and fully retracted. In one embodiment, radial vane storage module 210 can be configured to deploy radial vane 211 to a position between full extension and full retraction based on wind conditions current at the time of deployment, as described in more detail below.

In the illustrated embodiment, radial vane 211 couples to axle 212. In the illustrated embodiment, axle 212 couples to a motor 213. Generally, motor 213 is an otherwise conventional motor, configured to rotate axle 212 so as to extend and retract radial vane 211. Motor 213 can be configured as any appropriate mechanism by which to engage or disengage and/or extend and retract radial vane 211. In the illustrated embodiment, motor 213 engages and disengages radial vane 211 by means of axle 212. One skilled in the art will understand that the disclosed embodiments contemplate any suitable mechanism to engage and disengage and/or extend and retract radial vane 211 including, but not limited to, hand cranks, pulleys, chain drives, or other suitable mechanisms. In an alternate embodiment, motor 213 couples directly to radial vane 211.

In the illustrated embodiment, motor 213 also couples to a radial vane control module 214. As such, in one embodiment, motor 213 includes a mechanism configured to operate in response to a signal from radial vane control module 214. In one embodiment, radial vane control module 214 includes a control module such as a switch. In one embodiment, radial vane control module 214 is manual switch. In an alternate embodiment, radial vane control module 214 is a remotely operated electric switch.

In one embodiment, radial vane control module 214 is configured to communicate with a central controlling station, such as, for example, a control room (not shown) located at an offsite facility or at the base of a turbine stack. In one embodiment, radial vane control module 214 communicates with a control room through a wireless signal. In an alternate embodiment, radial vane control module 214 communicates with a control room through a wired or wire-line connection.

For example, in an exemplary operation, radial vane control module 214 receives a command signal from the control room. Generally, in one embodiment, the command signal is an engage signal or a disengage signal. As used herein, an “engage signal” is a signal requesting radial vane control module 214 to perform the operations necessary to engage (or extend) radial vane 211 to its fully extended position. Similarly, a “disengage signal” is a signal requesting radial vane control module 214 to perform the operations necessary to disengage (or retract) radial vane 211 to its fully retracted position. In an alternate embodiment, radial vane control module 214 is configured to receive an extend signal and a retract signal. In one embodiment, an “extend signal” is a signal requesting radial vane control module 214 to perform the operations necessary to engage (or extend) radial vane 211 to a position between the fully retracted position and the fully extended position. Similarly, a “retract signal” is a signal requesting radial vane control module 214 to perform the operations necessary to disengage (or retract) radial vane 211 to a position between the fully retracted position and the fully extended position. Thus, radial vane control module 214 can be configured to extend and retract radial vane 211 according to commands issued from a control room. Accordingly, a human or automated user can control radial vane 211 from a remote location, without having to scale a support pole 122 to engage/disengage radial vane 211.

In one embodiment, system 200 can be deployed adjacent to any vertical turbine and/or turbine stack. Additionally, in the illustrated embodiment, system 200 provides a framework for multiple radial vane storage modules 210, for example, as illustrated in FIG. 1. So configured, the operational control module can extend and/or retract multiple radial vanes 211, providing increased flexibility in optimizing the system configuration.

One skilled in the art will understand that some configurations of vertical wind turbine systems are installed in permanent installations. In the illustrated embodiment, system 200 can also be installed in a fixed location relative to a permanently installed turbine and/or turbine stack. In one embodiment, system 200 is installed adjacent to a single turbine stack. In an alternate embodiment, system 200 is installed adjacent to a plurality of turbine stacks. Generally, the placement of system 200 can be configured based on a variety of engineering principles, including, but not limited to, prevailing wind and other weather conditions at the installation site.

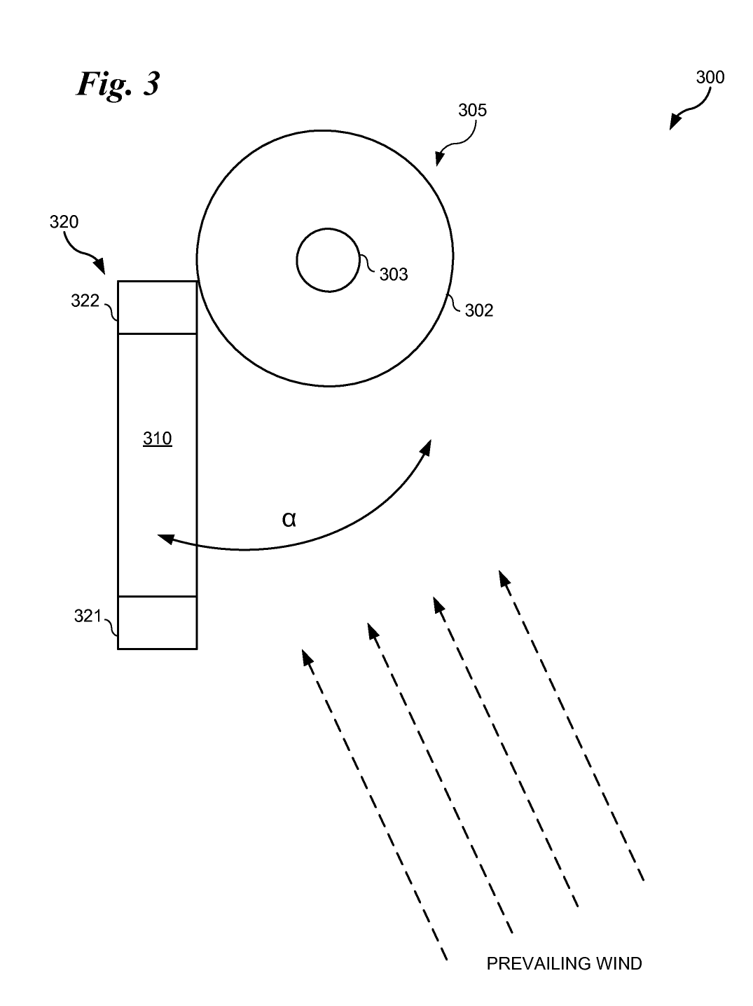

For example, FIG. 3 illustrates an exemplary configuration 300 of a radial vane support module 320 and turbine stack 305. In the illustrated embodiment, turbine stack 305 includes a turbine 302 coupled to, and configured to impart rotational energy to, a shaft 303. As illustrated, radial vane support module 320 is installed relative to turbine stack 305 such that radial vane storage module 310 forms an angle σ between turbine stack 305 and the prevailing winds. In one embodiment, angle σ is an angle of about 30 degrees to about 45 degrees. In one embodiment, angle σ is any angle at which engagement of a radial vane of storage module 310 increases fluid flow into turbine 302 of turbine stack 305. In one embodiment, angle σ is an angle determined by a user to provide an optimal range of extension and retraction configurations for the radial vane of storage module 210, once installed.

Additionally, one skilled in the art will understand that a vertical turbine spends one portion of its rotation turning “downwind” (with or in the direction of the fluid flow), and spends one portion of its rotation turning “upwind” (against or in the opposite direction of the fluid flow). In some embodiments, the turbine can be divided, conceptually, into two halves: a “power” side, rotating downwind, and a “drag” side, rotating upwind. One skilled in the art will understand that any one blade of a turbine will pass from the power side to the drag side and so forth, as the turbine revolves about its axis.

Generally, the resistance of the upwind rotation reduces the torque generated by the downwind rotation. Thus, in one embodiment, radial vane support module 320 is disposed relative to a turbine stack to increase fluid flow through the turbines in the turbine stack on the downwind rotation segment (the power side). In an alternate embodiment, radial vane support module 320 also decreases fluid flow in the upwind rotation segment of the turbine rotation (the drag side).

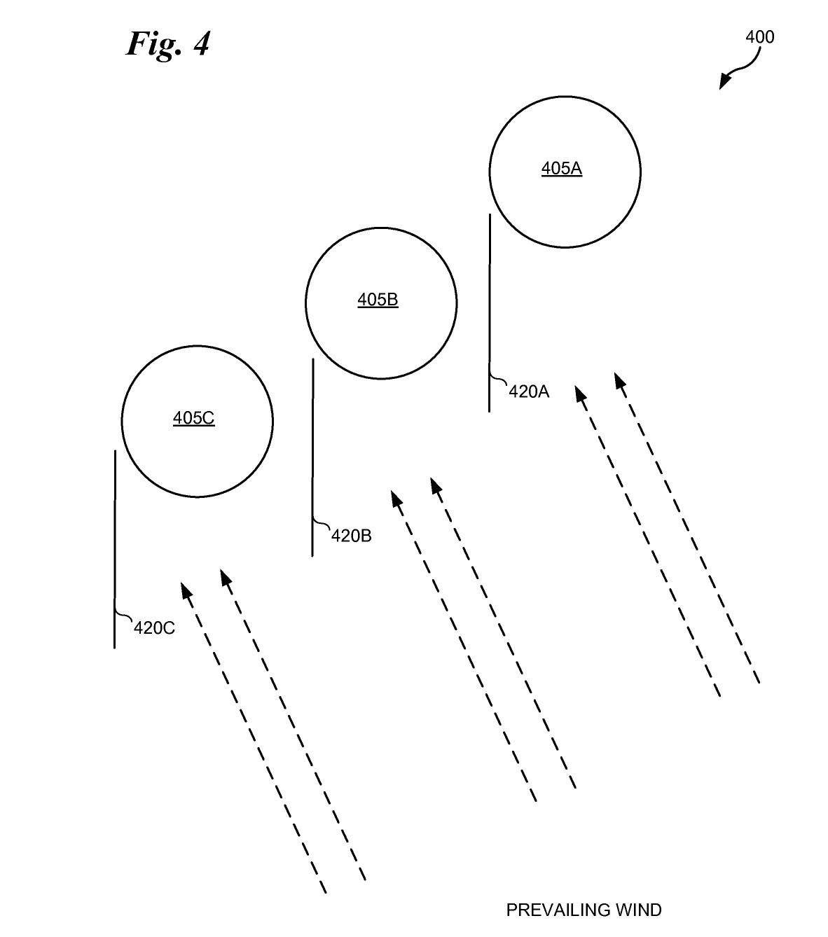

For example, in one embodiment, radial vane support module 320 can be deployed adjacent to two or more turbine stacks 305. FIG. 4 illustrates an exemplary configuration 400 of three turbine stacks 405(a, b, and c) arranged in a generally linear order. In the illustrated embodiment, turbine stacks 405 are shown arranged in a line roughly perpendicular to the prevailing wind direction. One skilled in the art will understand that the exact alignment of the turbine stacks 405, both with respect to the wind and to each other, can be configured to optimize electrical output of turbine stacks 405.

In the illustrated embodiment, a plurality of radial vane support modules 420(a, b, and c) is interwoven adjacent to the arrangement of turbine stacks 405. In particular, in the illustrated embodiment, a radial vane support module 420 is disposed adjacent to two turbine stacks 405 such that the radial vane of the support module 420 directs fluid flow into the power side of one turbine stack 405 while concurrently reducing or blocking fluid flow into the drag side of an adjacent turbine stack 405. For example, support module 420a directs fluid flow into the power side of turbine stack 405a and reduces fluid flow into the drag side of turbine stack 405b. Similarly, support module 420b directs fluid flow into the power side of turbine stack 405b and reduces fluid flow into the drag side of turbine stack 405c. As shown, a single radial vane support module 420 can be positioned to improve the performance of more than one turbine stack 405.

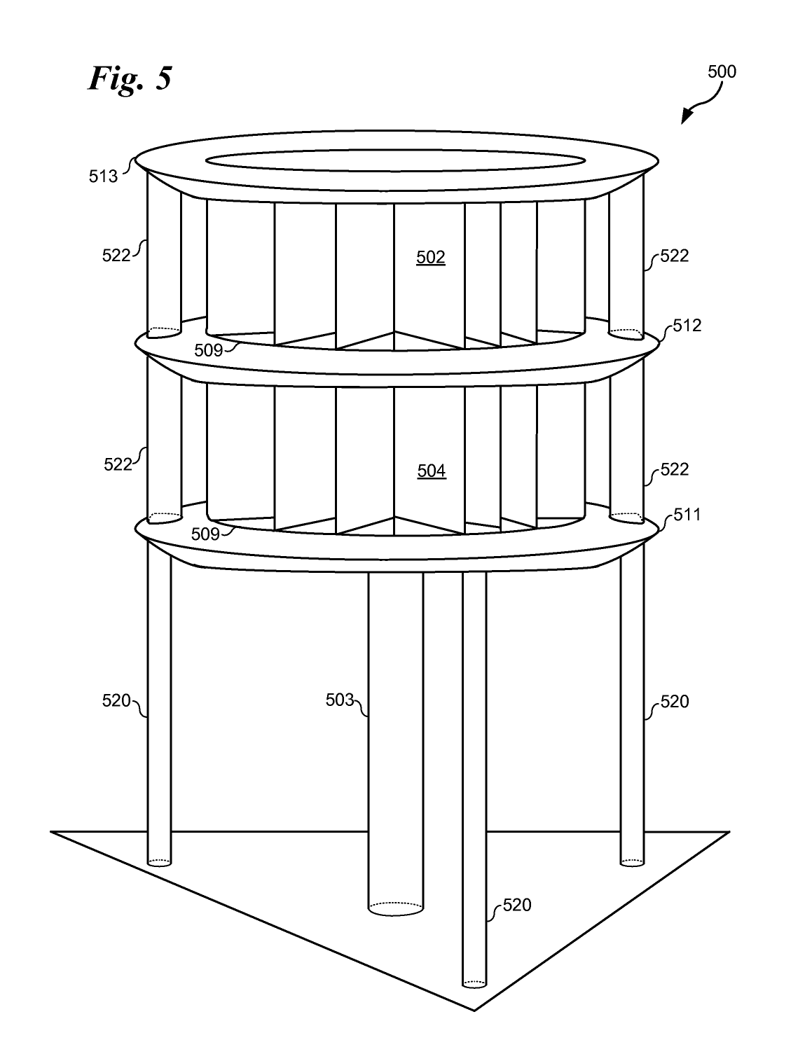

The performance of a turbine stack can also be improved by additional fluid funneling. For example, FIG. 5 illustrates an exemplary improved wind capture system 500. Generally, system 500 includes a plurality of wind capture aids disposed at the top and bottom of each turbine, which are configured to direct fluid flow into the turbines. As illustrated, system 500 includes a first turbine 502, a second turbine 504, a turbine shaft 503, a lower saucer vane 511, an intermediate saucer vane 512, and an upper saucer vane 513.

Generally, turbines 502 and 504 couple to turbine shaft 503 as described above. Additionally, in the illustrated embodiment, turbine 502 and turbine 504 are showed enclosed in a housing 509. Generally, housing 509 couples to and encloses a turbine such that the turbine blades are free to turn about the axis of rotation of the turbine.

One skilled in the art will understand that a turbine stack is generally configured with a support framework to support the rotating turbines and shaft. For ease of illustration, FIG. 5 omits some elements of the support framework, in order not to obscure aspects of the embodiments disclosed herein. As shown, system 500 includes three base support columns 520. One skilled in the art will understand that other numbers of support columns 520 can also be employed.

In the illustrated embodiment, support columns 520 elevate and support a lower saucer vane 511. Lower saucer vane 511 is a generally compressed toroid or annular structure defining an opening, the diameter of which is configured to allow shaft 503 to pass through lower saucer vane 511. In the illustrated embodiment, lower saucer vane 511 couples to the housing 509 of turbine 504. Generally, lower saucer vane 511 is configured to accelerate and direct into turbine 504 fluid flow that would otherwise pass beneath turbine 504.

Similarly, intermediate saucer vane 512 is a generally compressed toroid or annular structure defining an opening, the diameter of which is configured to allow shaft 503 to pass through intermediate saucer vane 512. In the illustrated embodiment, intermediate saucer vane 512 couples to the housing 509 of turbine 504 and the housing 509 of turbine 502. Generally, intermediate saucer vane 512 is configured to accelerate and direct into turbine 502 and turbine 504 fluid flow that would otherwise flow into either turbine 502 or turbine 504 at a junction between turbine 502 and turbine 504. So configured, intermediate saucer vane 512 can reduce turbulence and interference at the junction between two turbines, which generally improves airflow into the turbines.

System 500 also includes an upper saucer vane 513. In the illustrated embodiment, upper saucer vane 513 couples to the housing 509 of turbine 502. Generally, upper saucer vane 513 is configured to accelerate and direct into turbine 502 fluid flow that would otherwise pass above turbine 502. In the illustrated embodiment, upper saucer vane 513 is configured as a disk configured with a flat side and a rounded side. In an alternate embodiment, the flat side of upper saucer vane 513 is instead configured with an aerodynamically efficient gradation. One skilled in the art will understand that other configurations can also be employed.

In an alternate embodiment, such as wherein the turbine stack is configured with a single turbine, system 500 includes an upper saucer vane 513 and a lower saucer vane 511, but does not include an intermediate saucer vane 512. In an alternate embodiment, system 500 omits upper saucer vane 513. In an alternate embodiment, system 500 omits lower saucer vane 511. In an alternate embodiment, system 500 includes an intermediate saucer vane 512 in between each turbine in the turbine stack.

In the illustrated embodiment, lower saucer vane 511 couples to a plurality of interstitial support beams 522. In one embodiment, an interstitial support beam 522 is configured as a cylindrical beam disposed vertically between lower saucer vane 511 and the saucer vane immediately above it, which, in the illustrated embodiment, is intermediate saucer vane 512. In an alternate embodiment, one or more interstitial support beams 522 are configured in an elliptical or wing shape. In one embodiment, each interstitial support beam 522 disposed on the power side of turbine 504 is configured as a wing that directs fluid flow toward turbine 504. In one embodiment, each interstitial support beam 522 disposed on the drag side of turbine 504 is configured as a wing that directs fluid flow away from turbine 504.

In the illustrated embodiment, interstitial support beams 522 support and elevate intermediate saucer vane 512. As shown, intermediate saucer vane 512 also couples to a second set of interstitial support beams 522, which are configured as described above. Additionally, interstitial support beams 522 also support and elevate upper saucer vane 513 from intermediate saucer vane 512.

As described above, saucer vanes 512, 513, and 514 are configured to direct fluid flow into nearby turbines. Thus, generally, saucer vanes 512, 513, and 514 improve turbine performance over turbine stacks configured without the disclosed saucer vanes. Additionally, saucer vanes 512, 513, and 514 also accelerate fluid passing across the saucer vanes, which further increases the efficiency and performance of the turbines. Moreover, increased and accelerated fluid flow also increases the ability of the turbines to operate efficiently at lower wind speeds.

Additionally, one skilled in the art will understand that typical vertical turbine installations can be very large, on the order of fifteen to twenty feet in diameter, or larger. Thus, in one embodiment, saucer vanes 512, 513, and 514 can be configured such that writing, symbols, and/or images can be visible to the naked eye from a considerable distance. As such, saucer vanes 512, 513, and 514 can be configured to provide advertising, promotion, and/or other information to passers-by within visibility range.

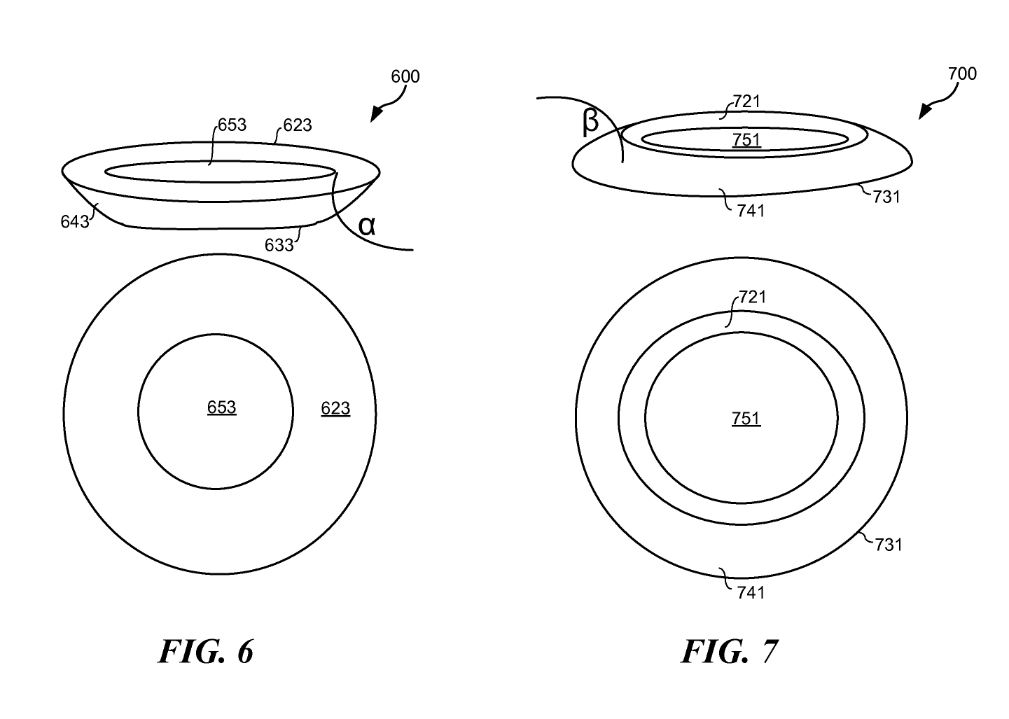

FIGS. 6, 7, and 8 provide additional detail regarding exemplary configurations of saucer vanes 512, 513, and 514. In particular, FIG. 6 provides additional detail regarding an exemplary upper saucer vane 600. As illustrated, upper saucer vane 600 includes an upper surface 623, a lower surface 633, and an angled surface 643. In the illustrated embodiment, vane 600 also defines an opening 653. In one embodiment, opening 653 is configured as a hole extending through vane 600 and having a diameter approximately commensurate with the diameter of a turbine shaft, such as turbine shaft 503 of FIG. 5, for example. In an alternate embodiment, opening 653 is configured as a hole having a diameter approximately commensurate with the diameter of a turbine housing, such as housing 509 of FIG. 5, for example. Generally, lower surface 633 is configured to couple to a turbine housing. Upper surface 623 is the surface of vane 600 opposite that of lower surface 633.

In the illustrated embodiment, the outer circumference of upper surface 653 is larger than the outer circumference of lower surface 633 such that angled surface 643 connecting upper surface 623 and lower surface 633 joins upper surface 623 at an angle α. Angle α can be any angle at which angled surface 643 directs into the turbine to which vane 600 couples fluid that would otherwise pass above the turbine. One skilled in the art will understand that upper saucer vane 600 can also be configured in shapes other than annular, such as square, elliptical, rectangular, or other suitable shapes. The disclosed embodiments contemplate and include such shapes.

FIG. 7 provides additional detail regarding an exemplary lower saucer vane 700. As illustrated, lower saucer vane 700 includes an upper surface 721, a lower surface 731, and an angled surface 741. In the illustrated embodiment, vane 700 also defines an opening 751. In one embodiment, opening 751 is configured as a hole extending through vane 700 and having a diameter approximately commensurate with the diameter of a turbine shaft, such as turbine shaft 503 of FIG. 5, for example. In an alternate embodiment, opening 751 is configured as a hole having a diameter approximately commensurate with the diameter of a turbine housing, such as housing 509 of FIG. 5, for example.

Generally, upper surface 721 is configured to couple to a turbine housing. Generally, lower surface 731 is the surface of vane 700 opposite that of upper surface 721. In the illustrated embodiment, the outer circumference of upper surface 721 is smaller than that of lower surface 731 such that angled surface 741 connecting upper surface 721 and lower surface 731 joins upper surface 721 at an angle β. Angle β can be any angle at which angled surface 741 directs into the turbine to which vane 700 couples fluid that would otherwise pass below the turbine. One skilled in the art will understand that lower saucer vane 700 can also be configured in shapes other than annular, such as square, elliptical, rectangular, or other suitable shapes. The disclosed embodiments contemplate and include such shapes.

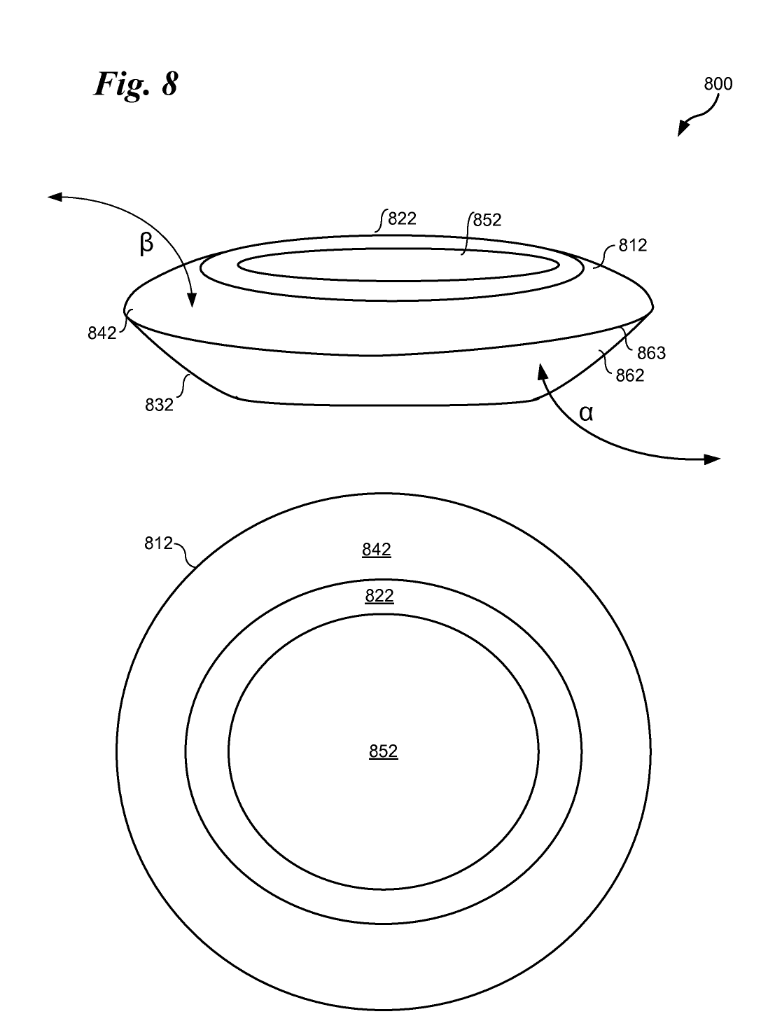

FIG. 8 provides additional detail regarding an exemplary intermediate saucer vane 800. As illustrated, intermediate saucer vane 800 includes an upper surface 822, a lower surface 832, an upper angled surface 842, a lower angled surface 862, and a midline 863. In the illustrated embodiment, vane 800 also defines an opening 852. In one embodiment, opening 852 is configured as a hole extending through vane 800 and having a diameter approximately commensurate with the diameter of a turbine shaft, such as turbine shaft 503 of FIG. 5, for example. In an alternate embodiment, opening 852 is configured as a hole having a diameter approximately commensurate with the diameter of a turbine housing, such as housing 509 of FIG. 5, for example.

Generally, upper surface 822 is configured to couple to a turbine housing. Similarly, lower surface 832 is the surface of vane 800 opposite that of upper surface 822, and is configured to couple to a turbine housing. In the illustrated embodiment, the outer circumference of midline 863 is larger than the outer circumference of lower surface 832 such that angled surface 862 running from lower surface 832 to midline 863 is configured at an angle α. Generally, midline 863 is the set of points at which angled surface 842 joins angled surface 862. Angle a can be any angle at which angled surface 862 directs into the turbine above which vane 800 couples fluid that would otherwise pass above the turbine. Similarly, in the illustrated embodiment, the outer circumference of upper surface 822 is smaller than that of midline 863 such that angled surface 842 running from upper surface 822 to midline 863 is configured at an angle β. Angle β can be any angle at which angled surface 842 directs into the turbine below which vane 800 couples fluid that would otherwise pass below the turbine. One skilled in the art will understand that intermediate saucer vane 800 can also be configured in shapes other than annular, such as square, elliptical, rectangular, or other suitable shapes. The disclosed embodiments contemplate and include such shapes.

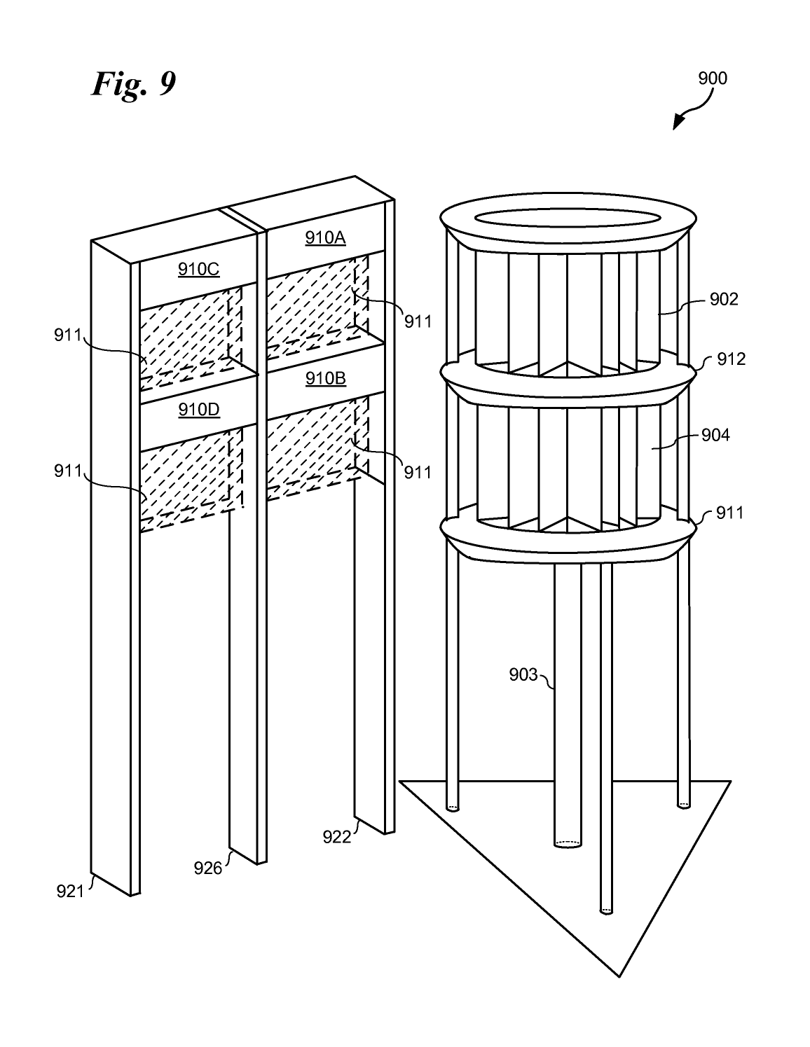

Referring now to FIG. 9, system 900 is an exemplary configuration employing both the novel radial vane embodiments disclosed herein and the novel saucer vane embodiments disclosed herein. Together, both embodiments significantly increase the fluid capture ability of the associated vertical turbines over prior art vertical turbine installations. In addition, the ability to retract the radial vanes provides a fluid capture enhancement that avoids many of the problems of the prior art. Specifically, the disclosed embodiments can provide dynamic fluid capture configuration in response to changing environmental conditions. In addition, the disclosed embodiments can be constructed of more rigid and durable material than prior art systems. These advantages greatly increase the effectiveness and life span of the disclosed embodiments over prior art systems.

System 900 also illustrates an alternative embodiment. Specifically, system 900 includes two columns of radial vanes storage modules 910. As shown, system 900 includes a first support pole 921, a second support pole 922, and a third support pole 926, disposed in between poles 921 and 922. In the illustrated embodiments, modules 910a and 910b couple to poles 922 and 926. Similarly, modules 910c and 910d couple to poles 921 and 926. So configured, system 900 can provide additional flexibility in increasing/decreasing wind flow into turbines 902 and 904. For example, contemporaneous environmental conditions may be such that fluid flow into the turbines is optimized with modules 910a and 910c fully extending their respective vanes, and with modules 910b and 910d partially extending their respective vanes. Accordingly, one skilled in the art will understand that the additional configuration options can be employed to further optimize fluid capture and energy transformation.

Referring now to FIG. 10, system 1000 illustrates an exemplary wind capture system configuration in accordance with one embodiment. System 1000 includes a turbine stack of five vertical turbines 1071, 1072, 1073, 1074, and 1075, each of which couples to a turbine shaft 1003. Generally, one skilled in the art will understand that wind passing through the turbines rotates the turbines, which imparts rotational energy to turbine shaft 1003.

System 1000 includes a control room 1050. Generally, control room 1050 houses various equipment for operation and maintenance of system 1000, including systems to convert rotational energy or shaft 1003 to electrical energy. Control room 1050 also includes a control module 1055. Generally, control module 1055 is configured to provide operational control to a user operating control module 1055. Operational control can include braking and/or stopping the turbines 1071-1075, and/or operation of one or more radial vanes, for example.

For example, in one embodiment, generally, the operational control module 1055 (or a user controlling module 1055) takes and/or receives various measurements to assess the current performance of the electricity generation system that comprises the various components described herein. Such measurements can be obtained by a sensor array, such as sensor array 1060, for example. Such measurements include, for example, ambient weather conditions (including temperature, humidity, barometric pressure and the like), current wind speed/direction, average wind speed/direction, expected wind speed/direction, turbine status, turbine speed, current torque generated by a turbine, electrical output of a generator coupled to shaft 1003, status of radial vane 1011, status of radial vane storage module 1010, and other suitable measurements.

Generally, module 1055 assesses the measurements taken/received and determines an “optimal configuration” for system 1000. Generally, the “optimal configuration” is configured to improve the electrical energy generation of the entire system, while maintaining operational safety and best practices for improving equipment longevity. In one embodiment, the optimal configuration includes a deployment position for one or more radial vanes 1011. As used herein, a “deployment position” is the position of a radial vane 1011 at a point between and including the fully extended position and the fully retracted position.

One skilled in the art will understand that the “optimal” configuration at any point in time can vary depending on the prevailing local weather conditions, the state and age of the equipment, and other suitable factors. As such, the operational configuration need not always match a theoretical optimization configuration. In one embodiment, the optimal configuration determined by the operational control module is an estimate of a local optimization.

Having determined the optimal configuration, in one embodiment, module 1055 sends a control signal to one or more radial vane storage modules 1010. In one embodiment, the control signal indicates the optimal configuration deployment position for the associated radial vane 1011. In an alternate embodiment, the control signal is an engage/disengage signal indicating to radial vane storage module 1010 that radial vane 1011 should be fully extended (engage signal) or fully retracted (disengage signal). In an alternate embodiment, the control signal is a movement signal indicating to radial vane storage module 1010 that radial vane 1011 should be repositioned (by extension or retraction) by some factor. In systems with multiple radial vanes 1011, the control signals can be directed to each storage module 1010 individually, collectively, or in groups.

Having received a control signal, radial vane storage module 1010 positions its associated radial vane 1011 according to the received control signal. Generally, a fully deployed/extended radial vane 1011 directs more fluid flow toward the turbines than a fully retracted radial vane 1011. Directing fluid flow toward the turbines increases the fluid flow through the turbines, thereby increasing the electricity produced. Thus, one skilled in the art will understand that repositioning radial vane 1011 changes the fluid dynamics of the system, and as such, changes the measurements observed by control module 1055. Accordingly, one skilled in the art will understand that control module 1055 can direct periodic repositioning of radial vanes 1011 in response to changes in the operational variables, which include the position of the radial vanes 1011.

Thus, a radial vane 1011 can be configured to improve the performance of one or more turbine stacks. For example, a method for improving fluid capture of a vertical turbine comprises deploying a radial vane storage module 1010 adjacent to a turbine stack such that an associated radial vane 1011 lies across the path of the prevailing fluid flow and directs fluid flow into and/or towards the downwind segment of a turbine 1071. As described above, control module 1055 can deploy and retract radial vane 1011 dynamically, based on changing local conditions.

For example, in one embodiment, in the event that the fluid velocity falls below a threshold minimum fluid velocity and radial vanes 1011 are retracted, system 1000 engages one or more radial vanes 1011 to a fully deployed position. In one embodiment, the threshold minimum fluid velocity is a predetermined value at which additional wind capture will aid in efficient power generation. Additionally, in the event that the fluid velocity exceeds a threshold maximum value and radial vanes 1011 are extended, system 1000 disengages one or more radial vanes 1011. In one embodiment, the threshold maximum fluid velocity is a predetermined value at which additional wind capture may cause damage to the turbines and/or other equipment. Thus, radial vanes 1011 can be deployed and disengaged to improve the performance of system 1000.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A system for improved fluid capture, comprising:
a first vertical turbine;
a first radial vane support module comprising a first vertical pole and a second vertical pole, wherein the first radial vane support module is disposed adjacent to the first vertical turbine;
wherein the first radial vane support module comprises a first radial vane storage module coupled to the first vertical support pole and to the second vertical support pole, the first radial vane storage module comprising a first motor and a first radial vane;
wherein the first radial vane comprises a first retractable panel;
wherein the first motor couples to the first radial vane and is configured to extend and retract the first radial vane.

2. The system of claim 1, further comprising:
the first radial vane support module further comprising a third vertical pole;
wherein the first radial storage module further couples to the third vertical pole; and
wherein the first radial vane further comprises a second retractable panel.

3. The system of claim 1, further comprising:
a second vertical turbine coupled vertically adjacent to the first vertical turbine;
a second radial vane storage module coupled to the first radial vane support module, the second radial vane storage module comprising a second motor and a second radial vane;
wherein the second motor couples to the second radial vane and is configured to extend and retract the second radial vane;
a second radial vane control module coupled to the second motor, the second radial vane control module configured to control operation of the second motor; and
wherein the second radial vane storage module is disposed adjacent to the second vertical turbine.

4. The system of claim 1, further comprising a lower saucer vane coupled to the first vertical turbine, the lower saucer vane configured to direct fluid into the first vertical turbine.

5. The system of claim 1, further comprising an upper saucer vane coupled to the first vertical turbine, the upper saucer vane configured to direct fluid into the first vertical turbine.

6. The system of claim 5, further comprising a lower saucer vane coupled to the first vertical turbine opposite the upper saucer vane, the lower saucer vane configured to direct fluid into the first vertical turbine.

7. The system of claim 6, further comprising:
a second vertical turbine coupled vertically adjacent to the first vertical turbine;
an intermediate saucer vane coupled to the first vertical turbine and the second vertical turbine, the intermediate saucer vane configured to direct fluid into the second vertical turbine and into the first vertical turbine;
a second radial vane storage module coupled to the first radial vane support module, the second radial vane storage module comprising a second motor and a second radial vane;
wherein the second motor couples to the second radial vane and is configured to extend and retract the second radial vane;
a second radial vane control module coupled to the second motor, the second radial vane control module configured to control operation of the second motor; and
wherein the second radial vane storage module is disposed adjacent to the second vertical turbine.

8. The system of claim 1, further comprising: a first radial vane control module coupled to the first motor, the first radial vane control module configured to control the operation of the first motor.

9. The system of claim 1, wherein the fluid comprises water.

10. A system for improved fluid capture, comprising:
a first vertical turbine; and
a saucer vane module coupled to the first vertical turbine and configured to direct fluid into the first vertical turbine.

11. The system of claim 10, wherein the saucer vane module comprises a lower saucer vane coupled to the first vertical turbine beneath the first vertical turbine and configured to direct fluid into the first vertical turbine.

12. The system of claim 11, wherein the saucer vane module further comprises an upper saucer vane coupled to the first vertical turbine opposite the lower saucer vane and configured to direct fluid into the first vertical turbine.

13. The system of claim 10, wherein the saucer vane module comprises an upper saucer vane coupled to the first vertical turbine above the first vertical turbine and configured to direct fluid into the first vertical turbine.

14. The system of claim 10, further comprising:
a first radial vane support module comprising a first vertical pole and a second vertical pole, wherein the first radial vane support module is disposed adjacent to the first vertical turbine;
wherein the first radial vane support module comprises a first radial vane storage module coupled to the first vertical support pole and the second vertical support pole, the first radial vane storage module comprising a first motor and a first radial vane;
wherein the first radial vane comprises a first retractable panel;
wherein the first motor couples to the first radial vane and is configured to extend and retract the first radial vane; and
a first radial vane control module coupled to the first motor, the first radial vane control module configured to control the operation of the first motor.

15. The system of claim 10, further comprising:
a second vertical turbine coupled vertically adjacent to the first vertical turbine; and
an intermediate saucer vane coupled to the first vertical turbine and the second vertical turbine, the intermediate saucer vane configured to direct fluid into the second vertical turbine and into the first vertical turbine.

16. The system of claim 15, further comprising:
a first radial vane support module comprising a first vertical pole and a second vertical pole, wherein the first radial vane support module is disposed adjacent to the first vertical turbine;
wherein the first radial vane support module comprises a first radial vane storage module coupled to the first vertical support pole and the second vertical support pole, the first radial vane storage module comprising a first motor and a first radial vane;
wherein the first radial vane comprises a first retractable panel;
wherein the first motor couples to the first radial vane and is configured to extend and retract the first radial vane;
a first radial vane control module coupled to the first motor, the first radial vane control module configured to control the operation of the first motor;
a second radial vane storage module coupled to the first radial vane support module, the second radial vane storage module comprising a second motor and a second radial vane;
wherein the second motor couples to the second radial vane and is configured to extend and retract the second radial vane;
a second radial vane control module coupled to the second motor, the second radial vane control module configured to control operation of the second motor; and
wherein the second radial vane storage module is disposed adjacent to the second vertical turbine.

17. The system of claim 10, wherein the fluid comprises air.

18. The system of claim 10, wherein the fluid comprises water.

19. A method for improved fluid capture, comprising:
deploying a radial vane module adjacent to a vertical turbine;
measuring a fluid velocity;
determining the radial vane module state; and
in the event that the fluid velocity falls below a threshold fluid velocity and the radial vane module state comprises a disengaged value, operating a motor of the radial vane module to engage a radial vane of the radial vane module.

20. The method of claim 19, wherein in the event that the fluid velocity exceeds the threshold fluid velocity and the radial vane module state comprises an engaged value, operating the motor of the radial vane module to disengage the radial vane of the radial vane module.
